(19) United States
(12) Patent Application Publication
(10) Pub. No.: US 2024/0351233 A1
(43) Pub. Date: Oct. 24, 2024

(54) ROTARY CUTTER UNIT

(71) Applicant: NIPPON TUNGSTEN CO., LTD., Fukuoka (JP)

(72) Inventors: Yasunori TSUJI, Fukuoka (JP); Aiko MOTOISHI, Fukuoka (JP)

(73) Assignee: NIPPON TUNGSTEN CO., LTD., Fukuoka (JP)

(21) Appl. No.: 18/641,625

(22) Filed: Apr. 22, 2024

(30) Foreign Application Priority Data
Apr. 24, 2023 (JP) 2023-070596

(51) Int. Cl. B26F 1/38; B26D 7/26; B26F 1/42

(52) U.S. Cl. CPC B26F 1/384; B26D 7/265; B26F 1/42

(57) ABSTRACT

A rotary cutter unit includes: a cutter roll; an anvil roll parallel to the cutter roll; two pairs of rotatably-supporting portions, each pair disposed at respective opposite ends of each of the two rolls; a pair of air springs each installed to apply pressure to a respective one of the pair of rotatably-supporting portions of one roll; and a pair of spring elements each installed to apply pressure to a respective one of the pair of rotatably-supporting portions of the other roll, in a direction opposed to the pressure application of the air springs. The air springs and spring elements apply pressures to respective corresponding ones of the pairs of rotatably-supporting portions, in opposite directions sandwiching the two rolls. Each rotatably-supporting portion is slidable in directions which cause pressure applied from a corresponding one of the pair of air springs and the pair of spring elements to increase and decrease.

### TECHNICAL FIELD

The present invention relates to a rotary cutter unit for continuously cutting a thin strip-shaped material such as a nonwoven fabric or a film into a given shape.

### BACKGROUND ART

Generally, a rotary cutter unit is used to cut a thin strip-shaped material into a given shapes. The rotary cutter unit comprises: a cutter roll comprising a cutting blade having a cutting geometry; and an anvil roll comprising a receiving part for the cutting blader. The cutter roll and the anvil roll are arranged in parallel, and rotated in opposite directions while being kept in closely-adjacent or contact relation to each other, whereby the rotary cutter unit can continuously press-cut the material.

In such a rotary cutter unit, the two rolls are liable to collide against each other during operation to generate vibration, thus giving rise to the need to take measures to suppress the vibration. For example, the following Patent Document 1 discloses a rotary cutting device configured to reduce impact-caused vibration of a drum such as an anvil drum or a cutter drum, through the use of vibration attenuating means equipped with a passive damper as an elastic member. Further, the following Patent Document 2 discloses a rotary working device in which an actuator is provided outside a cutting unit, thereby making it possible to: suppress vibration; reduce the height dimension of a frame of the cutting unit to lower the center of gravity of the cutting unit; and facilitate replacement of the cutting unit.

On the other hand, it is known that an air (pneumatic) spring is used in a cutting device to adjust pressure or position. For example, the following Patent Document 3 discloses a printing/cutting apparatus using an air spring aiming at fine adjustment of pressure. Further, the following Patent Documents 4 and 5 disclose air springs for rotary cutters, aiming at adjusting the positions of a knife rotor and a plane rotor.

### CITATION LIST

### Patent Document

Patent Document 1: JP-A 2012-218149
Patent Document 2: JP-A 2011-156623
Patent Document 3: U.S. Pat. No. 4,531,929
Patent Document 4: JP-A H08-112798
Patent Document 5: JP-A H10-138196

### SUMMARY OF INVENTION

### Technical Problem

The passive damper used in the rotary cutting device disclosed in the Patent Document 1 can quickly reduce vibration caused by impact at the time of collision of a movable roll against a fixed roll. However, the passive damper cannot suppress the occurrence of the impact itself, nor can it suppress the external vibration. Moreover, this rotary cutting device uses a relatively large number of components due to the use of a plurality of elastic members as the passive damper, etc., which is likely to lead to structural complication, resulting in not only complicated disassembling and reassembling work during roll replacement but also increased cost.

In the Patent Document 2, vibration can be suppressed by using the actuator installed outside the cutting unit to bring a movable roll into contact with a fixed roll. However, the actuator cannot suppress the occurrence of impact itself, which is likely to lead to chipping of a cutting blade. Moreover, the actuator cannot completely absorb external vibration transmitted to the cutting unit.

Therefore, the present invention addresses a technical problem of providing a structurally simplified rotary cutter unit capable of suppressing impact to be received by two rolls consisting of a cutter roll and an anvil roll, while allowing the two rolls to avoid receiving vibration directly from the outside, thereby preventing chipping of a cutting edge of a cutting blade of the cutter roll and damage to the surface of the anvil roll, and maintaining cutting performance over a long period of time.

### Solution to Technical Problem

In order to solve the above technical problem, the present invention provides a rotary cutter unit comprising: a cutter roll comprising a roll body having an outer circumferential surface, and a cutting blade positioned at the outer circumferential surface, the cutting blade having a cutting geometry; an anvil roll disposed parallel to the cutter roll, the anvil roll comprising a roll body having an outer circumferential surface configured to receive the cutting blade; a pair of rotatably-supporting portions each disposed at a respective one of opposite ends of the cutter roll; a pair of rotatably-supporting portions each disposed at a respective one of opposite ends of the anvil roll; a pair of air springs A each installed to apply pressure to a respective one of the pair of rotatably-supporting portions of one of two rolls consisting of the cutter roll and the anvil roll; and a pair of spring means B each installed to apply pressure to a respective one of the pair of rotatably-supporting portions of the other roll, in a direction opposed to a direction of the pressure application of the pair of air springs A, wherein the pair of air springs A and the pair of spring means B apply pressures to respective corresponding ones of the pairs of rotatably-supporting portions, in opposite directions sandwiching the two rolls, and wherein each rotatably-supporting portion of the pairs of rotatably-supporting portions of the two rolls is slidable in directions which cause the pressure applied from a corresponding one of the pair of air springs A and the pair of spring means B to increase and decrease.

In the present invention, the rotary cutter unit may further comprises a pair of air springs C installed between the pair of rotatably-supporting portions of the cutter roll and the pair of rotatably-supporting portions of the anvil roll, to apply pressure to at least one of the pair of rotatably-supporting portions of the cutter roll and the pair of rotatably-supporting portions of the anvil roll, in a direction along a direction which causes the pressure applied from the pair of air springs A to increase or decrease. Further, the pair of spring means B may be composed of a pair of air springs.

### Advantageous Effects of Invention

According to the present invention, impact to be received by the two rolls can be suppressed by using the pair of air springs and the pair of spring means to apply pressures to respective corresponding ones of the two pairs of rotatably-supporting portions in opposite directions sandwiching the two rolls. It is also possible to suppress impact caused by a collision of the two rolls, etc. Further, it becomes possible to prevent the two rolls from receiving vibration directly from the outside. This makes it possible to prevent chipping of a cutting edge of the cutting blade of the cutter roll and damage to the surface of the anvil roll, thereby maintaining cutting performance over a long period of time.

### BRIEF DESCRIPTION OF DRAWINGS

FIG. 1A is a front view schematically showing an exemplary configuration of a rotary cutter unit according to a first embodiment of the present invention.

FIG. 1B is a schematic perspective view of the rotary cutter unit in FIG. 1A.

FIG. 2 is a perspective view schematically showing an exemplary configuration of a rotationally-supporting portion.

FIG. 3 is a front view schematically showing an exemplary configuration of a rotary cutter unit according to a second embodiment of the present invention.

FIG. 4 is a front view schematically showing an exemplary configuration of a rotary cutter unit according to a third embodiment of the present invention.

FIG. 5 is a front view schematically showing an exemplary configuration of a conventional rotary cutter unit.

### DESCRIPTION OF EMBODIMENTS

A rotary cutter unit of the present invention has the following configuration.

The rotary cutter unit comprises:
a cutter roll comprising a roll body having an outer circumferential surface, and a cutting blade positioned at the outer circumferential surface, the cutting blade having a cutting geometry;
an anvil roll disposed parallel to the cutter roll, the anvil roll comprising a roll body having an outer circumferential surface configured to receive the cutting blade;
a pair of rotatably-supporting portions each disposed at a respective one of opposite ends of the cutter roll;
a pair of rotatably-supporting portions each disposed at a respective one of opposite ends of the anvil roll;
a pair of air springs A each installed to apply pressure to a respective one of the pair of rotatably-supporting portions of one of two rolls consisting of the cutter roll and the anvil roll; and
a pair of spring means B each installed to apply pressure to a respective one of the pair of rotatably-supporting portions of the other roll, in a direction opposed to a direction of the pressure application of the pair of air springs A,
wherein the pair of air springs A and the pair of spring means B apply pressures to respective corresponding ones of the pairs of rotatably-supporting portions, in opposite directions sandwiching the two rolls,
and wherein each rotatably-supporting portion of the pairs of rotatably-supporting portions of the two rolls is slidable in directions which cause the pressure applied from a corresponding one of the pair of air springs A and the pair of spring means B to increase and decrease.

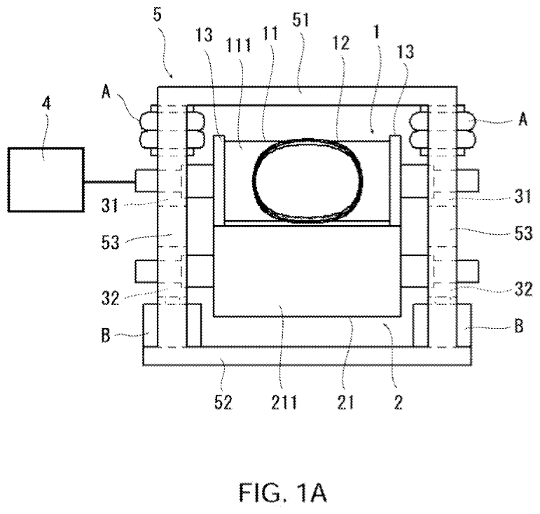

Referring mainly to FIGS. 1A and 1B, the details of the configuration of the rotary cutter unit of the present invention will now be described.

A cutter roll 1 comprises a roll body 11 having an outer circumferential surface 111, and a cutting blade 12 positioned at the outer circumferential surface 111 and having a desired cutting geometry. The cutter roll 1 further comprises a pair of guide rings 13 provided on both sides of the cutting blade 12. The height dimension of each of the guide rings 13 is set to be substantially equal to a distance from the outer circumferential surface 111 to a cutting edge of the cutting blade 12.

An anvil roll 2 comprises a roll body 21 having an outer circumferential surface 211. The anvil roll 2 is disposed parallel to the cutter roll 1, so that the outer circumferential surface 211 of the anvil roll 2 can receive the cutting blade 12 of the cutter roll 1.

A pair of rotatably-supporting portions 31 are provided to rotatably hold opposite ends of the cutter roll 1, respectively, and a pair of rotatably supporting portion 32 is provided to rotatably hold opposite ends of the anvil roll 2, respectively.

A drive unit 4 is configured to rotationally drive at least one of the cutter roll 1 and the anvil roll 2 (in FIG. 1A, one end (one of the opposite ends) of the cutter roll 1). For example, the drive unit 4 may be a servomotor. It should be noted that the drive unit 4 is omitted in FIG. 1B.

A pair of air springs A are installed to apply pressure, respectively, to the pair of rotatably-supporting portions of one of the two rolls 1, 2, which is rotationally driven by the drive unit 4, in a direction which causes respective centers of the two rolls 1, 2 to linearly come close to or come into contact with each other. In FIG. 1A, the pair of air springs A are installed to apply pressure, respectively, to the pair of rotatably-supporting portions 31 of the roll rotationally driven by the drive unit 4. Alternatively, the pair of air springs A may be installed to apply pressure, respectively, to the pair of rotatably-supporting portions 32 of the other, roll which is not rotationally driven by the drive unit 4. In a case where both the two rolls 1, 2 are rotationally driven by the drive unit 4, the pair of air springs A are installed to apply pressure, respectively, to the pair of rotatably-supporting portions at the opposite ends of one of the two rolls 1, 2. Based on the above configuration, the pair of air springs A can apply pressure to the two rolls 1, 2. Further, each of the air springs A can deform in response to external force to attenuate vibration.

A pair of spring means B are installed to apply pressure, respectively, to the pair of rotationally-supporting portions 32 of the other, roll to which the pair of air springs A are not installed, in a direction opposed to a direction of the pressure application of the pair of air springs A. The spring means B may be an oil-hydraulic cylinder, a pneumatic (air) cylinder, or an air spring.

Each rotatably-supporting portion of the pair of rotatably-supporting portions 31 rotatably holding the opposite ends of the cutter roll 1 and the pair of rotatably-supporting portions 32 rotatably holding the opposite ends of the anvil roll 2 is slidable in directions which cause the pressure applied from a corresponding one of the pair of air springs A and the pair of spring means B to increase and decrease.

As above, the pair of air springs A and the pair of spring means B are installed to apply pressures to respective corresponding ones of the pairs of rotatably-supporting portions 31, 32 in opposite directions sandwiching the two rolls 1, 2, and each rotatably-supporting portion of the pairs of rotatably-supporting portions 31, 32 is installed slidably in directions which cause the pressure applied from a corresponding one of the pair of air springs A and the pair of spring means B to increase and decrease, whereby the pair of air springs A and the pair of spring means B can attenuate vibration generated between the two rolls 1, 2.

Specifically, even when the rotary cutter unit of the present invention receives vibration, the two rolls 1, 2, which are slidably sandwiched by the pair of air springs A and the pair of spring means B, vibrate in the same direction without being separated from each other. This makes it possible to suppress a collision of the two rolls, and prevent external vibration from being transmitted directly to the rolls. Further, when vibration occurs, the rolls press the pair of air springs A, which makes it possible to obtain a vibration attenuating effect of the pair of air springs A. The vibration attenuating effect of the pair of air springs A is higher than that of a commonly-used spring means (such as an oil-hydraulic cylinder or a pneumatic cylinder). Thus, it is possible to reduce the level of chipping of the cutting edge of the cutting blade 12 of the cutter roll 1 and damage to the surface of the anvil roll 2. It should be noted that even when an oil-hydraulic cylinder or a pneumatic cylinder is employed as the spring means B, it can be slightly retracted (contracted) in response to external force to attenuate vibration, although inferior to the air spring A. On the other hand, from a viewpoint of enhancing a vibration attenuating effect of the pair of spring means B, the pair of spring means B may be composed of a pair of air springs.

Here, applying pressures to respective corresponding ones of the pairs of rotatably-supporting portions in opposite directions sandwiching the two rolls means that the pair of air springs A and the pair of spring means B apply pressures to respective corresponding ones of the pairs of rotatably-supporting portions of the two rolls, in directions which cause the cutter roll and the anvil roll to linearly come close to or come into contact with each other.

Further, being slidable in directions which cause the pressure applied from a corresponding one of the pair of air springs A and the pair of spring means B to increase and decrease means that when the pressure applied from a corresponding one of the pair of air springs A and the pair of spring means B increases or decreases, the two rolls can move in directions which cause them to linearly come close to or away from each other.

In addition to the above configuration, the rotary cutter unit may comprise a pair of air springs C installed between the pair of rotatably-supporting portions 31 of the cutter roll 1 and the pair of rotatably-supporting portions 32 of the anvil roll 2, to apply pressure to at least one of the pair of rotatably-supporting portions of the cutter roll and the pair of rotatably-supporting portions of the anvil roll, in a direction along a direction which causes the pressure applied from the pair of air springs A to increase or decrease. This configuration is more effective in suppressing impact between the two rolls during operation and attenuating external vibration.

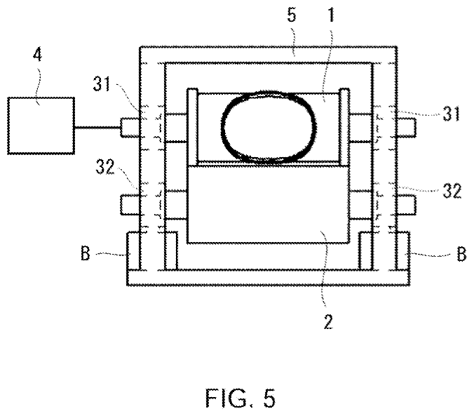

On the other hand, in a conventional rotary cutter unit using only a pair of spring means B installed to press an anvil roll 2 as a movable roll toward a cutter roll 1 as a fixed roll, as shown in FIG. 5, when vibration occurs due to a collision between a cutting blade 12 of the cutter roll 1 and the anvil roll 2 during operation, the spring means B can slightly attenuate the vibration, but continues to press the anvil roll 2. This causes not only chipping of a cutting edge of the cutting blade 12 of the cutter roll 1, but also damage to the surface of the anvil roll 2. Further, since the cutter roll 1 as a fixed roll is fixed to a cutter unit frame 5, external vibration is transmitted from the cutter roll 1, and consequently impact between the two rolls increases.

As above, in the conventional rotary cutter unit in which one of the two rolls is fixed to the cutter unit frame, when vibration occurs, the movable roll collides with the fixed roll, or the fixed roll collides with the movable roll. Moreover, since external vibration is transmitted to the fixed roll, impact between the two rolls increases, and therefore it is impossible to prevent chipping of the cutting edge of the cutting blade of the cutter roll, and damage to the surface of the anvil roll.

Next, the present invention will be described in more detail based on embodiments thereof.

### First Embodiment

FIG. 1A is a front view schematically showing an exemplary configuration of a rotary cutter unit according to a first embodiment of the present invention, and FIG. 1B is a schematic perspective view of the rotary cutter unit.

The rotary cutter unit according to the first embodiment comprises a cutter unit frame 5, a cutter roll 1, an anvil roll 2, two pairs of rotatably-supporting portions 31, 32, a drive unit 4, a pair of air springs A, and a pair of spring means B each composed of a pneumatic cylinder. The cutter unit frame 5 comprises a top plate 51, a bottom plate 52, and plural pillars 53. The cutter roll 1 and the anvil roll 2 are arranged inside the cutter unit frame 5. Each rotatably-supporting portion of the two pairs of rotatably-supporting portions 31, 32 is composed of a bearing box, and a pair of bearing boxes 31 and a pair of bearing boxes 32 are provided, respectively, to the cutter roll 1 and the anvil roll 2. The pair of air springs A and the pair of spring means B are installed to apply pressures to respective corresponding ones of the pairs of bearing boxes as the pairs of rotatably-supporting portions in directions sandwiching the two rolls 1, 2. Specifically, the pair of air springs A are installed to apply pressure, respectively, to the pair of bearing boxes 31 at respective opposite ends of the cutter roll 1 provided with the drive unit 4, and the pair of spring means B are installed to apply pressure, respectively, to the pair of bearing boxes 32 at respective opposite ends of the anvil roll 2. The pair of spring means B are installed to apply pressure, respectively, to the pair of bearing boxes 32 in a direction opposite to a direction of the pressure application of the pair of air springs A.

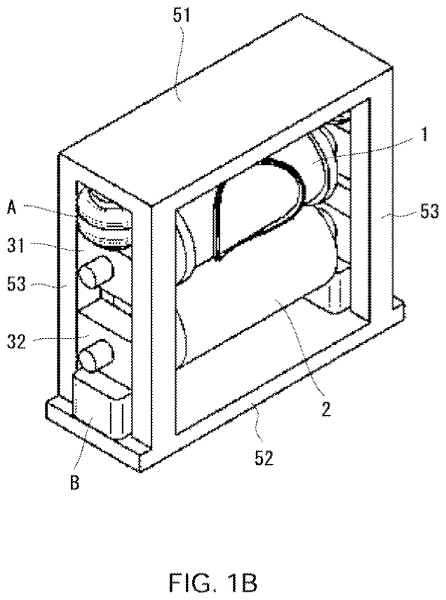

Each of the bearing boxes 31, 32 is installed slidably in directions which cause the pressure applied from a corresponding one of the pair of air springs A and the pair of spring means B to increase and decrease. Specifically, as shown in FIG. 2, each of the bearing boxes 31, 32 is installed slidably along two of the pillars 53 of the cutter unit frame 5. In FIG. 2, the reference signs 1a, 2a denote, respectively, one end of the cutter roll 1 and one end of the anvil roll 2. Here, although not illustrated in FIG. 2, an upper limit stopper and a lower limit stopper may be provided to define an upper limit position and a lower limit position of a sliding movement of each of the bearing boxes 31, 32, respectively.

A vibration meter with an acceleration sensor was mounted to each rotatably-supporting portion (bearing box) in the rotary cutter unit according to the first embodiment and the conventional rotary cutter unit in FIG. 5, to measure vibration for one minute. As a result, the rotary cutter unit according to the first embodiment could reduce the maximum value of vibration amplitude by 30% as compared to the rotary cutter unit having the configuration in FIG. 5. Further, the cutter roll 1 and the anvil roll 2 of the conventional rotary cutter unit in FIG. 5 were checked after 20 million rotations of the two rolls 1, 2 without nipping a material therebetween, under the condition that pressure was applied to the two rolls 1, 2 using the pair of spring means B, and the cutter roll 1 and the anvil roll 2 of the rotary cutter unit according to the first embodiment were checked after 20 million rotations of the two rolls 1, 2 without nipping a material therebetween, under the condition that pressure was applied to the two rolls 1, 2 using the pair of air springs A and the pair of spring means B. As a result, in the conventional rotary cutter unit, the cutting edge of the cutting blade 12 of the cutter roll 1 underwent chipping, and the surface of the anvil roll 2 was damaged. In contrast, in the rotary cutter unit according to the first embodiment, there was no notable damage to the cutting blade 12 of the cutter roll 1 and the surface of the anvil roll 2.

### Second Embodiment

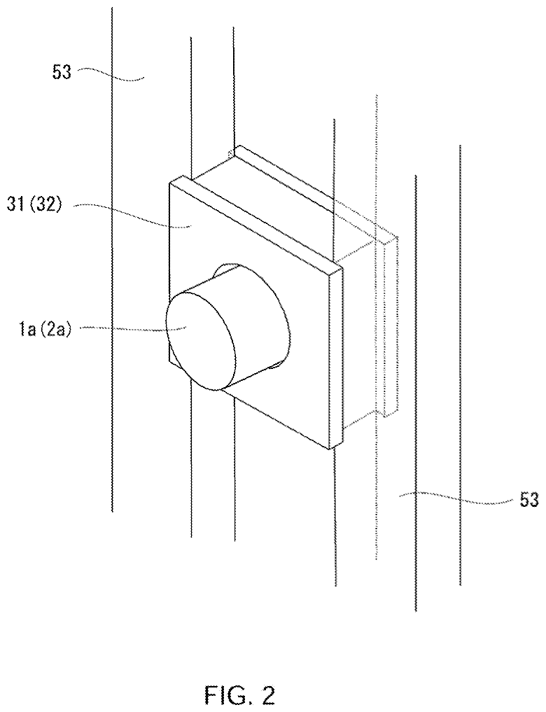

FIG. 3 is a front view schematically showing an exemplary configuration of a rotary cutter unit according to a second embodiment of the present invention. In addition to the configuration of the rotary cutter unit according to the first embodiment, the rotary cutter unit according to the second embodiment comprises a pair of air springs C. This pair of air springs C are installed between the pair of rotatably-supporting portions 31 of the cutter roll 1 and the pair of rotatably-supporting portions 32 of the anvil roll 2, to apply pressures to respective ones of the pairs of rotatably-supporting portions 31, 32, in directions along respective directions which cause the pressure applied from the pair of air springs A to increase and decrease. In the second embodiment, the pair of air springs C are configured and installed to apply pressures to both the pair of rotatably-supporting portions 31 and the pair of rotatably-supporting portions 32. Alternatively, the pair of air springs C may be configured and installed to apply pressure to at least one of the pair of rotatably-supporting portions 31 and the pair of rotatably-supporting portions 32. As above, in the second embodiment, the pair of air springs C is provided in addition to pair of the air springs A and the pair of spring means B, so that it becomes possible to enhance the vibration attenuation effect.

A vibration meter with an acceleration sensor was mounted to each rotatably-supporting portion (bearing box) in the rotary cutter unit according to the second embodiment and the conventional rotary cutter unit in FIG. 5, to measure vibration for one minute. As a result, the rotary cutter unit according to the second embodiment could reduce the maximum value of vibration amplitude by 40% as compared to the rotary cutter unit having the configuration in FIG. 5.

### Third Embodiment

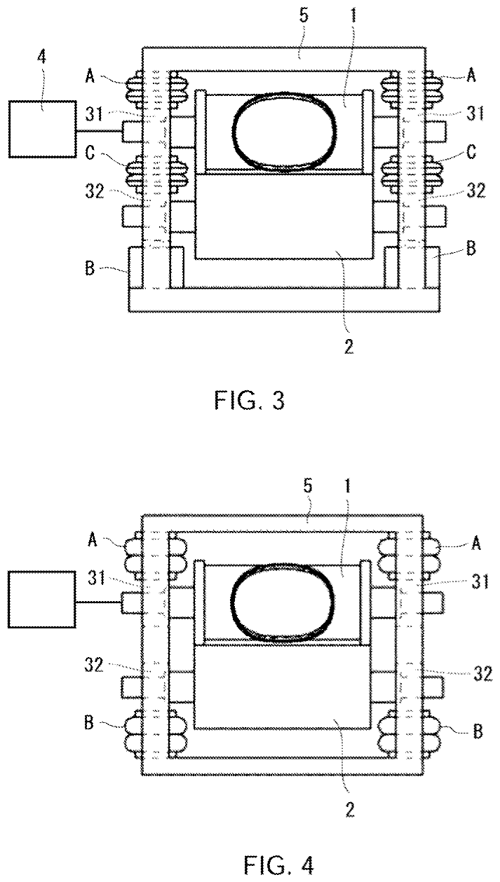

FIG. 4 is a front view schematically showing an exemplary configuration of a rotary cutter unit according to a third embodiment of the present invention. The third embodiment is different from the first embodiment in that each of the pair of spring means B is composed of an air spring C. That is, in the first embodiment, a pneumatic cylinder is use as each of the pair of spring means B. In the third embodiment, the pneumatic cylinder is changed to an air spring. As above, in the third embodiment, each of the pair of spring means B is composed of an air spring, so that it becomes possible to enhance the vibration attenuation effect.

A vibration meter with an acceleration sensor was mounted to each rotatably-supporting portion (bearing box) in the rotary cutter unit according to the third embodiment and the conventional rotary cutter unit in FIG. 5, to measure vibration for one minute. As a result, the rotary cutter unit according to the third embodiment could reduce the maximum value of vibration amplitude by 50% as compared to the rotary cutter unit having the configuration in FIG. 5.

### LIST OF REFERENCE SIGNS

1: cutter roll
1a: end of cutter roll
11: roll body
111: outer circumferential surface
12: cutting blade
13: guide ring
2: anvil roll
2a: end of anvil roll
21: roll body
211: outer circumferential surface
31, 32: rotatably-supporting portion (bearing box)
4: drive unit
5: cutter unit frame
51: top plate
52: bottom plate
53: pillar
A: air spring
B: spring means
C: air spring

1. A rotary cutter unit comprising:
a cutter roll comprising a roll body having an outer circumferential surface, and a cutting blade positioned at the outer circumferential surface, the cutting blade having a cutting geometry;
an anvil roll disposed parallel to the cutter roll, the anvil roll comprising a roll body having an outer circumferential surface configured to receive the cutting blade;
a pair of rotatably-supporting portions each disposed at a respective one of opposite ends of the cutter roll;
a pair of rotatably-supporting portions each disposed at a respective one of opposite ends of the anvil roll;
a pair of air springs A each installed to apply pressure to a respective one of the pair of rotatably-supporting portions of one of two rolls consisting of the cutter roll and the anvil roll; and
a pair of spring means B each installed to apply pressure to a respective one of the pair of rotatably-supporting portions of the other roll, in a direction opposed to a direction of the pressure application of the pair of air springs A,
wherein the pair of air springs A and the pair of spring means B apply pressures to respective corresponding ones of the pairs of rotatably-supporting portions, in opposite directions sandwiching the two rolls,
and wherein each rotatably-supporting portion of the pairs of rotatably-supporting portions of the two rolls is slidable in directions which cause the pressure applied from a corresponding one of the pair of air springs A and the pair of spring means B to increase and decrease.

2. The rotary cutter unit as claimed in claim 1, further comprising a pair of air springs C installed between the pair of rotatably-supporting portions of the cutter roll and the pair of rotatably-supporting portions of the anvil roll, to apply pressure to at least one of the pair of rotatably-supporting portions of the cutter roll and the pair of rotatably-supporting portions of the anvil roll, in a direction along a direction which causes the pressure applied from the pair of air springs A to increase or decrease.

3. The rotary cutter unit as claimed in claim 1, wherein each of the pair of spring means B is composed of an air spring.
